(19) United States
(12) Patent Application Publication
(10) Pub. No.: US 2024/0413510 A1
(43) Pub. Date: Dec. 12, 2024

(54) BATTERY DEVICE

(71) Applicant: TOYOTA JIDOSHA KABUSHIKI KAISHA, Toyota-shi (JP)

(72) Inventors: Hiroaki NISHINO, Toyota-shi (JP); Kenji BABA, Toyota-shi (JP); Haruhiko MURASE, Nagoya-shi (JP)

(73) Assignee: TOYOTA JIDOSHA KABUSHIKI KAISHA, Toyota-shi (JP)

(21) Appl. No.: 18/597,084

(22) Filed: Mar. 6, 2024

(30) Foreign Application Priority Data
Jun. 7, 2023 (JP) 2023-0943 14

(51) Int. Cl. H01M 50/691; B60R 16/03; H01M 50/204; H01M 50/249

(52) U.S. Cl. CPC H01M 50/691; B60R 16/03; H01M 50/204; H01M 50/249; H01M 2220/20

(57) ABSTRACT

The battery device includes a battery pack assembly mounted on a support member. The battery pack assembly includes a battery pack and a tray positioned below the battery pack. The tray includes a frame and a bottom plate leading to the frame. The frame has an upper surface that supports the battery pack and a lower surface that is supported by the support member. The bottom plate has a drain hole.

### CROSS-REFERENCE TO RELATED APPLICATION

This application claims priority to Japanese Patent Application No. 2023-094314 filed on Jun. 7, 2023, incorporated herein by reference in its entirety.

### BACKGROUND

### 1. Technical Field

The present disclosure relates to a battery device.

### 2. Description of Related Art

WO2016/129385 discloses a power storage device. The power storage device includes a plurality of battery packs and a storage battery board. The battery packs are housed in the storage battery board.

### SUMMARY

In the power storage device described in WO2016/129385, water may be generated due to factors such as dew condensation on the surface of the battery pack. When the generated water accumulates in the power storage device, the safety of the power storage device may be affected. However, WO2016/129385 does not take measures against the water that may be generated in this way.

The present disclosure has been made in view of the above problem, and an object of the present disclosure is to provide a battery device in which safety can be improved by draining water generated in the battery device.

A battery device according to the present disclosure includes a battery pack assembly mounted on a support member. The battery pack assembly includes a battery pack, and a tray positioned below the battery pack. The tray includes a frame, and a bottom plate connected to the frame. The frame includes an upper surface that supports the battery pack and a lower surface supported by the support member. The bottom plate has a drain hole.

With the battery device of the present disclosure, water adhering to the surface of the battery pack due to factors such as dew condensation can be received by the tray. With the drain hole formed in the tray, the water on the tray can be drained from a desired location. This leads to an improvement in the safety of the battery device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an example of a configuration of a main part of a battery device according to an embodiment;

FIG. 2 is a perspective view of the battery assembly (battery pack assembly) shown in FIG. 1;

FIG. 3 is a top view of a tray supported by a pair of rails;

FIG. 4 is a diagram for explaining an arrangement location of a drain hole according to a first modification of the embodiment;

FIG. 5A is a diagram for explaining the arrangement location of the drain hole according to a second modification of the embodiment;

FIG. 5B is a diagram for explaining the arrangement location of the drain hole according to a second modification of the embodiment; and

FIG. 6 is a diagram for explaining a configuration of a tray according to a third modification of the embodiment.

### DETAILED DESCRIPTION OF EMBODIMENTS

Embodiments of the present disclosure will be described with reference to the accompanying drawings. In the drawings, the same reference numerals are assigned to the same elements, and redundant descriptions are omitted or simplified.

### 1. Configuration of Battery Device

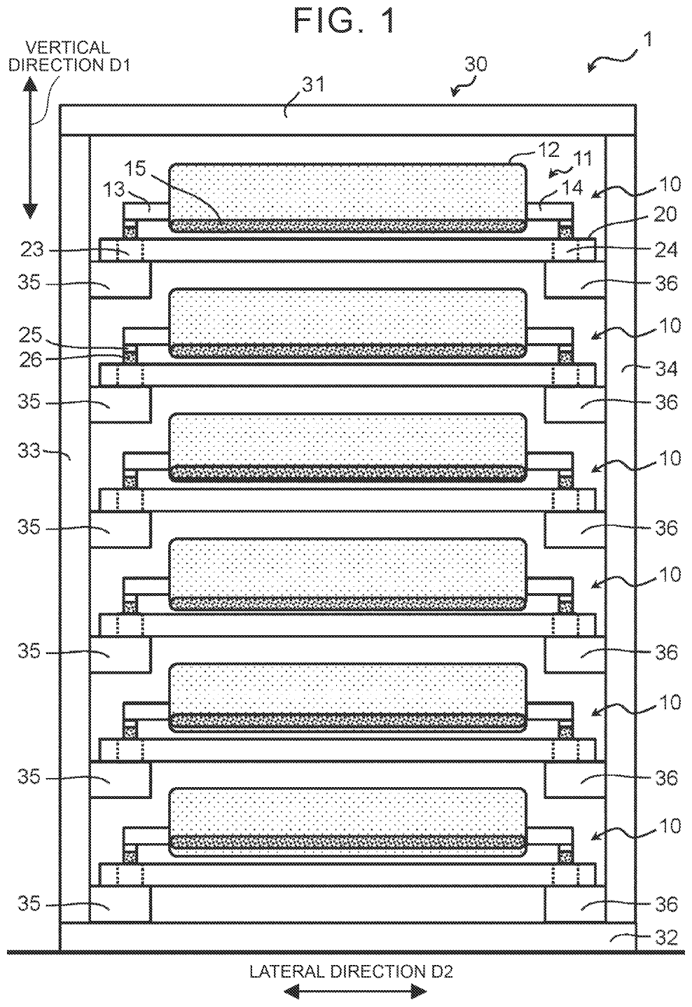

FIG. 1 is a diagram schematically illustrating an exemplary configuration of a main of the battery device 1 according to the embodiment. The battery device 1 is installed in a stationary place. The battery device 1 is also referred to as a stationary power supply. The battery device 1 is configured to store electric power supplied from the outside and supply electric power to a predetermined electric power supply target. The battery device 1 can be used, for example, as a backup power supply (emergency power supply) in a power failure (including an emergency in a natural disaster or the like).

The battery device 1 includes a battery pack assembly (or simply a battery assembly) 10 and a support 30. The battery assembly 10 is an assembly of the battery pack 11 and the tray 20. The number of battery assemblies 10 mounted on the battery device 1 may be one, but is basically a plurality. In the exemplary embodiment shown in FIG. 1, six battery assemblies 10 are stacked and accommodated in the support 30 in the vertical direction D1 (vertical direction) of the battery device 1.

In the present embodiment, the battery pack 11 is an in-vehicle battery pack. That is, the in-vehicle battery pack is diverted as the battery pack 11 of the battery device 1. Thus, cost reduction of the battery device 1 and effective utilization of resources can be achieved. More specifically, the in-vehicle battery pack may be a used product after being used on a vehicle, or may be a new product.

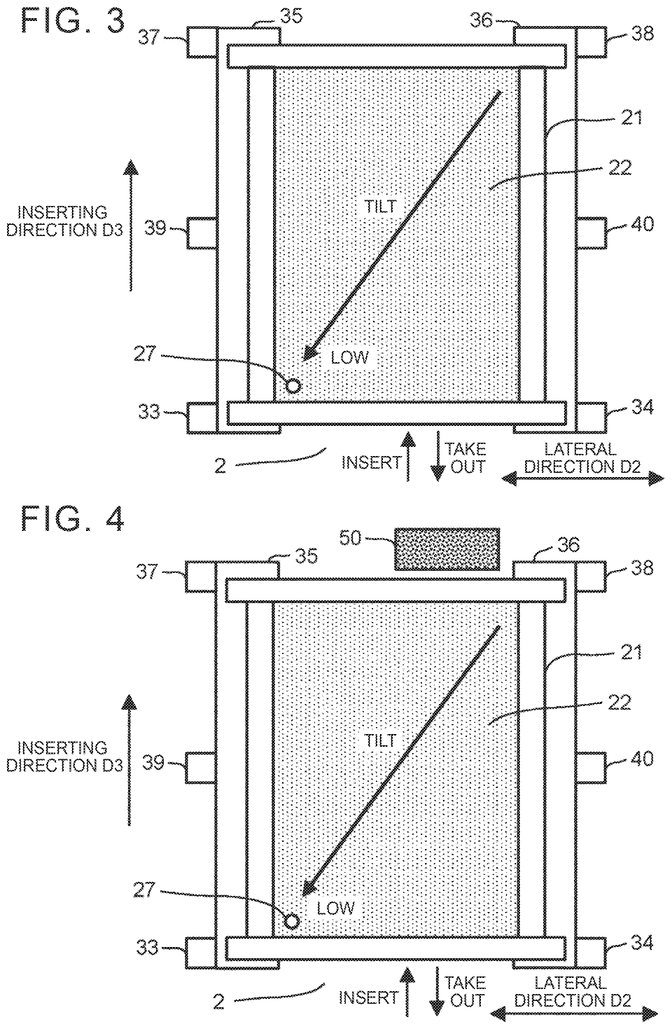

The respective battery assemblies 10 are moved into and out of the support 30 from a predetermined direction (from the inserting direction D3 shown in FIG. 3). FIG. 1 is a view of the support 30 in which the battery assembly 10 is accommodated from the direction of the access port 2 (refer to FIG. 3).

The support 30 has, for example, a rectangular parallelepiped skeleton structure. In FIG. 1, the frame members 31 to 34 located on the sides of the access port 2 among the plurality of frame members included in the support 30 are illustrated. The frame members 31 and 32 extend in the lateral direction D2 (horizontal direction) at the upper end and the lower end of the support 30, respectively. The frame members 33 and 34 extend in the vertical direction D1 at respective ends of the support 30 in the lateral direction D2.

The support 30 further includes a pair of rails 35 and 36 for each battery assembly 10 that support the battery assembly 10. The pair of rails 35 and 36 extend along the depth of the page in of FIG. 1. The pair of rails 35 and 36, together with the frame members 33 and 34, for example, are fixed to the other frame members 37 and 38, and the reinforcing members 39 and 40 (see FIG. 3). The rails 35 and 36 correspond to an example of a “support member” according to the present disclosure.

In addition, the battery device 1 includes a battery assembly 10 and a support 30, as well as “other components” that are not shown. Other components include, for example, power conversion units (including boost converters) 50 (see FIG. 4), electronic control units (ECU), and electric equipment such as high voltage relays. Other components also include, for example, wire harnesses (including high voltage cables and connectors) and cooling device components (e.g., coolant piping, pumps, radiators, radiator fans, and reservoir tanks). As an example, in the battery device 1, the components used on the vehicle together with the in-vehicle battery pack are also diverted to these “other components”. As a result, cost reduction and effective utilization of resources can be more effectively achieved.

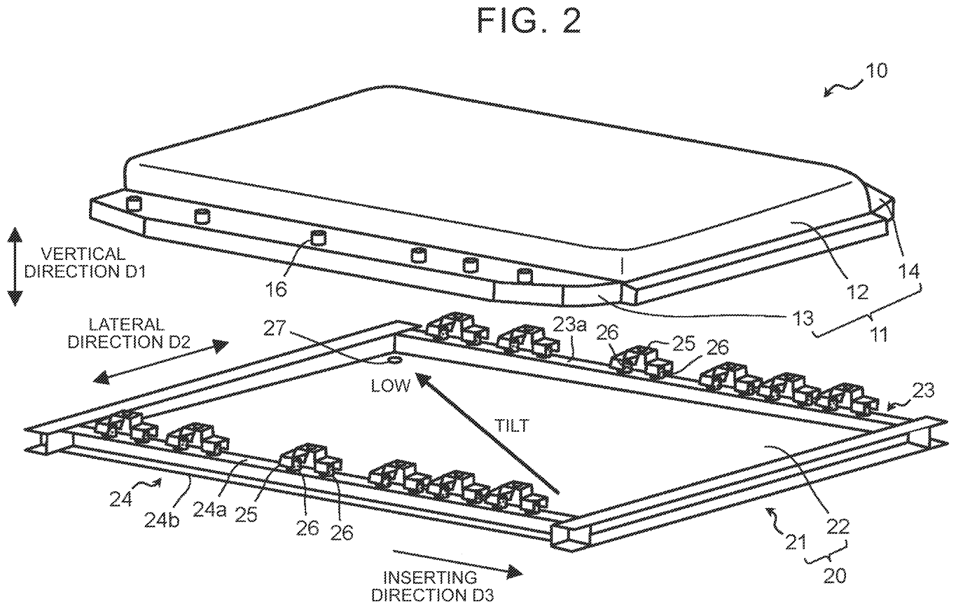

Next, a specific configuration of the battery assembly 10 will be described referring to FIG. 1 and to FIG. 2. FIG. 2 is a perspective view of the battery assembly 10 shown in FIG. 1.

The battery pack 11 includes a pack main body 12 and a pair of fixing portions 13 and 14. The pack main body 12 houses a plurality of secondary battery cells (not shown) and a cooler 15. The cooler 15 constitutes a part of the above-described cooling device. The cooler 15 exchanges the coolant flowing therein with the plurality of secondary battery cells in the pack main body 12. As a result, the plurality of secondary battery cells is cooled.

The tray 20 is located below the battery pack 11. The tray 20 includes a frame 21 and a bottom plate 22. The frame 21 is formed in a rectangular frame shape, for example. The bottom plate 22 is connected to the frame 21. The frame 21 has a pair of frame portions 23 and 24 located on both sides in the lateral direction D2. Each of the pair of frame portions 23 and 24 has an upper surface 23a and a 24a that support the battery pack 11. The pair of frame portions 23 and 24 have a lower surface 23b and a 24b supported by the rails 35 and 36, respectively.

More specifically, a plurality of brackets 25 for fixing the battery pack 11 to the tray 20 are attached to each of the upper surface 23a and 24a. The pair of fixing portions 13 and 14 of the battery pack 11 are fixed to the pair of frame portions 23 and 24 via the plurality of brackets 25, respectively. This fixing can be performed, for example, by fastening using a fastener such as a bolt 16.

In addition, each of the plurality of brackets 25 may be directly attached to the frame portion 23 or 24. On the other hand, as shown in FIG. 2, each of the plurality of brackets 25 may be attached to the frame portion 23 or 24 via the insulator 26. The use of the insulator 26 is supplemented as follows. As described above, the battery pack 11 is an in-vehicle battery pack. The battery pack used in the battery device 1 can be required to have a higher withstand voltage than the in-vehicle battery pack. Therefore, by interposing the insulator 26 between the battery pack 11 and the tray 20, when the in-vehicle battery pack that does not satisfy the withstand voltage required by the battery device 1 is diverted to the battery pack 11, the insulation property of the battery pack 11 can be appropriately secured without the need to increase the withstand voltage of the battery pack 11 itself.

### 2. Drain Hole

As shown in FIG. 2, the bottom plate 22 of the tray 20 has a drain hole 27. The drain hole 27 is formed so as to penetrate the bottom plate 22.

Broadly speaking, the bottom plate 22 may not be inclined with respect to the horizontal plane as long as it has the drain hole 27. In addition, in the present embodiment, the bottom plate 22 is inclined so as to be lower toward the drain hole 27 as shown in FIG. 2.

In addition, broadly speaking, the position of the drain hole 27 on the bottom plate 22 is not particularly limited, and may be, for example, the center of the bottom plate 22. In addition, in the present embodiment, the drain hole 27 is formed at the corner (more specifically, one of the four corners) of the bottom plate 22 as shown in FIG. 2. In addition, when the drain hole 27 is formed in the corner of the bottom plate 22, the drain hole 27 may be formed in any one of the three corners other than the corner shown in FIG. 2. Alternatively, the drain hole 27 may be formed in each of two or more corners. The bottom plate 22 may be inclined so as to be lowered toward each of a plurality of corners where the drain hole 27 is formed.

Further, in the present embodiment, the position of the drain hole 27 on the bottom plate 22 is determined in consideration of the following viewpoint. FIG. 3 is a top view of the tray 20 supported by a pair of rails 35 and 36. As shown in FIG. 3, the drain hole 27 is formed at an end of the bottom plate 22 located closer to the access port 2 of the battery assembly 10. More specifically, the drain hole 27 is formed in one of the corners on the side of the end. When the drain hole 27 is formed at the end of the bottom plate 22 located closer to the access port 2, the drain hole 27 may be formed at a portion other than the corner at the end, unlike the embodiment shown in FIG. 3. In the case where the drain hole 27 is formed at a portion other than the corner at the end, the bottom plate 22 may be inclined so as to be lower from the end on the side far from the access port 2 toward the end on the side close to the access port 2.

In addition, the drain hole 27 is circular as an example, but is not limited to a circular shape, and may have any shape such as an elongated hole shape (including a slit shape). The number of the drain holes 27 may be two or more. This also applies to the following modifications.

### Effect

As described above, in the battery device 1 according to the present embodiment, the battery pack 11 is combined with the tray 20 as the battery assembly 10. The tray 20 includes a bottom plate 22. Water may adhere to the surface of the battery pack 11 due to, for example, condensation. Further, the coolant leaked from the coolant pipe or the cooler 15 may adhere to the surface of the battery pack 11. According to the bottom plate 22, for example, water adhering to the surface of the battery pack 11 in this way can be prevented from falling into the battery pack 11 in the lower stage. A drain hole 27 is formed in the bottom plate 22. Accordingly, it is possible to prevent water from overflowing from the tray 20. More specifically, by selecting the position of the drain hole 27, water can be discharged from a desired position such as a position not overlapping with the battery pack 11 in a top view. This leads to suppression of occurrence of a short circuit in the battery pack 11 or an electric device connected thereto, that is, to improvement in safety of the battery device 1.

Further, the bottom plate 22 according to the present embodiment is inclined so as to be lower toward the drain hole 27. Thus, the drainage performance of the tray 20 can be improved.

Further, the drain hole 27 according to the present embodiment is formed at a corner of the bottom plate 22. Accordingly, the position of the drain hole 27 can be determined so that the water falling from the drain hole 27 is less likely to be applied to the battery pack 11 in the lower stage.

Furthermore, the drain hole 27 according to the present embodiment is formed at the end of the bottom plate 22 located on the side close to the access port 2 of the battery assembly 10. It can be said that the end is a portion where the components of the battery device 1 such as the above-described electric equipment are not disposed in the vicinity in order to prevent the battery assembly 10 from being taken in and out of the support 30. By forming the drain hole 27 in such a portion, water can be drained from the tray 20 while avoiding water from being applied to the component.

### 3. Modification

The position of the drain hole 27 on the bottom plate 22 may be determined in consideration of the following viewpoints. of FIG. 4 is a diagram for explaining an arrangement location of the drain hole 27 according to the first modification of the embodiment. FIG. 4 is a top view similar to FIG. 3. As a premise, in the first modification, the above-described power conversion unit 50, which is one of the electrical devices connected to the battery pack 11, is provided for each battery pack 11, for example. The respective power conversion units 50 are arranged at the same height as that of the battery pack 11 to be connected and at the back of the inserting direction D3 as shown in FIG. 4.

In addition, the drain hole 27 is formed at an end (e.g., a corner of the end) of the bottom plate 22, which is located on the other side of the arrangement location of the power conversion unit 50, in a top view of the bottom plate 22 (i.e., FIG. 4). By forming the drain hole 27 at the end on the side away from the power conversion unit 50 as described above, it is possible to drain the power conversion unit 50 from the tray 20 while easily avoiding drainage. In addition, the wire harness connecting the power conversion unit 50 and the battery pack 11 can be easily prevented from being drained.

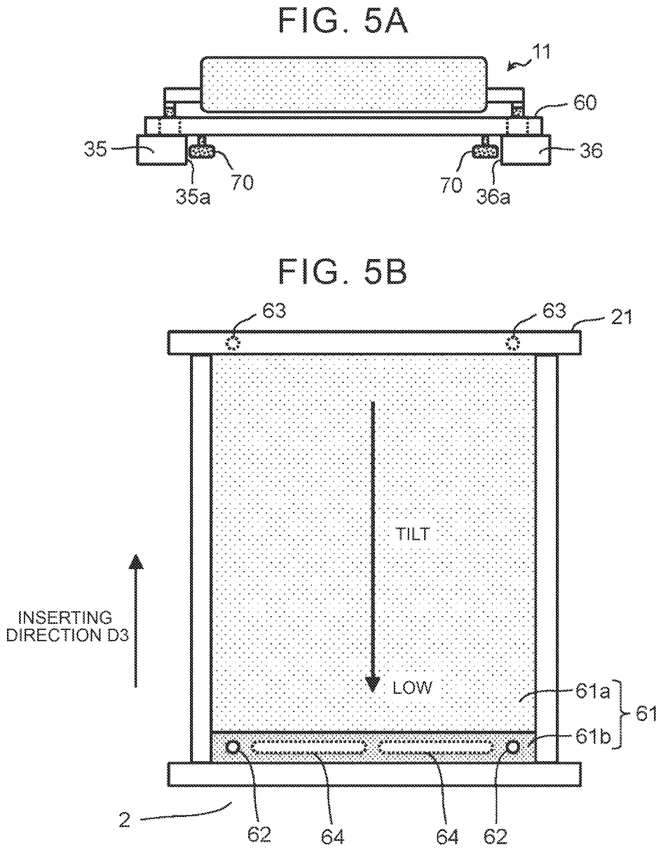

Next, FIG. 5A and FIG. 5B are diagrams for describing an arrangement location of the drain hole 62 according to the second modification of the embodiment. The tray 60 according to the second modification is different from the tray 20 shown in FIG. 2 in that a bottom plate 61 is provided instead of the bottom plate 22.

As a premise, in the second modification, four cam followers 70 are used in order to be able to position the battery assembly 10 with respect to the lateral direction D2 when the battery assembly 10 is inserted into the support 30. The bottom plate 61 is formed with two attachment holes 62 for mounting two of the four cam followers 70, respectively. In front of the two attachment holes 62 in the inserting direction D3, two attachment holes 63 are formed for mounting the remaining two cam followers 70, respectively. The four cam followers 70 are attached to the corresponding attachment holes 62 or 63 when the battery assembly 10 is inserted. When the battery assembly 10 is inserted, the two cam followers 70 move along the inner side 35a of one rail 35, and the remaining two cam followers 70 move along the inner side 36a of the other rail 36. The battery assembly 10 is inserted into the support 30 while being guided by the four cam followers 70 in this manner. As a result, the battery assembly 10 is positioned with respect to the lateral direction D2.

When the insertion of the battery assembly 10 is completed, the two cam followers 70 of the four cam followers on the side close to at least the access port 2 are removed from the tray 60. In the second variant, the two attachment holes 62 after the two cam followers 70 have been removed are shared as two “drain holes” 62.

More specifically, for example, the two drain holes 62 are respectively provided at two corners of the bottom plate 61 located closer to the access port 2 as shown in FIG. 5B. The bottom plate 61 does not necessarily have to be inclined with respect to the horizontal plane, but may have the inclined portion 61a and the horizontal portion 62b, for example, as shown in FIG. 5B. The two drain holes 62 are formed in the horizontal portion 62b. The inclined portion 61a is inclined so as to be lower from the front toward the rear of the inserting direction D3 (that is, toward the drain hole 62). In addition, another drain hole 64 as represented by a broken line may be formed in the horizontal portion 62b together with the two drain holes 62.

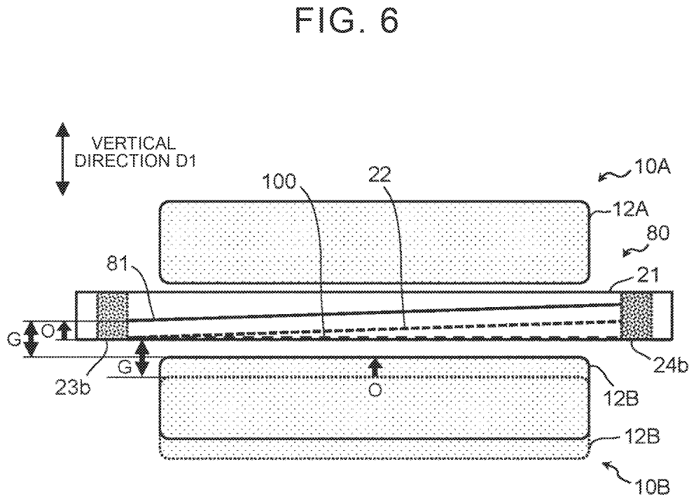

Next, FIG. 6 is a diagram for describing a configuration of a tray 80 according to a third modification of the embodiment. The tray 80 according to the third modification is different from the tray 20 shown in FIG. 2 in that a bottom plate 81 is provided instead of the bottom plate 22. FIG. 6 shows the battery assembly 10A, which is one of the plurality of battery assemblies 10, including the pack main body 12A and the tray 80, and the pack main body 12B of the battery assembly 10B at the lower part of one stage of the battery assembly 10A.

The bottom plates 22 and 100 are also shown in FIG. 6 together with the bottom plate 81 for comparison. The lines of the bottom plates 81 and 22 shown in FIG. 6 are obtained at the end positions of the bottom plates 81 and 22 close to the access port 2. The bottom plate 100 is horizontal without inclination and is located at the same height as the lower surface 23b and 24b of the frame 21. The gap G in FIG. 6 corresponds to the minimum required gap between the bottom plate of the upper battery assembly 10A and the lower pack main body 12B from the viewpoint of the performance of the battery device 1. Therefore, in the embodiment of the bottom plate 100, the pack main body 12B cannot be brought closer to the battery assembly 10A than the position represented by the broken line due to the restriction of the gap G. As shown in FIG. 6, the height of the lowest position of the bottom plate 22 is the same as that of the bottom plate 100. Therefore, even in the case of the bottom plate 22, in order to secure the gap G, the pack main body 12B cannot be brought closer to the battery assembly 10A than the position represented by the broken line.

On the other hand, as shown in FIG. 6, the bottom plate 81 is disposed above 5 the lower surface 23b and 24b of the frame 21 by the offset O even at the lowest portion. Accordingly, the pack main body 12B can be brought close to the battery assembly 10A to a position indicated by a solid line while securing the gap G. That is, the distance between the battery assembly 10A and the battery assembly 10B in the vertical direction D1 can be shortened by the offset O. According to such a raised bottom structure, it is possible to suppress an increase in the center of gravity of the battery device 1 caused by the stacking of the battery packs 11, and thus the stability (earthquake resistance) of the battery device 1 is improved.

What is claimed is:

1. A battery device comprising a battery pack assembly mounted on a support member, wherein:
the battery pack assembly includes
a battery pack, and
a tray positioned below the battery pack and including a frame and a bottom plate connected to the frame;
the frame includes an upper surface that supports the battery pack and a lower surface supported by the support member; and
the bottom plate has a drain hole.

2. The battery device according to claim 1, wherein the bottom plate is inclined to descend toward the drain hole.

3. The battery device according to claim 1, wherein, in a top view of the bottom plate, the drain hole is provided at an end of the bottom plate that is positioned opposite to a disposition location of an electric device connected to the battery pack.

4. The battery device according to claim 1, wherein:
the battery device includes an access port for the battery pack assembly to a support including the support member; and
the drain hole is provided at an end of the bottom plate that is positioned closer to the access port.

5. The battery device according to claim 1, wherein the drain hole is provided at a corner of the bottom plate.

6. The battery device according to claim 1, wherein the drain hole is used also as an attachment hole for a cam follower that guides the battery pack assembly by moving along a wall surface of the support member when the battery pack assembly is inserted into a support including the support member.

7. The battery device according to claim 1, wherein:
the battery device is installed at a stationary location; and
an in-vehicle battery pack is diverted as the battery pack.
